(19) United States
(12) Patent Application Publication
(10) Pub. No.: US 2012/0038960 A1
(43) Pub. Date: Feb. 16, 2012

(54) Electro-optical logic techniques and circuits

(76) Inventors: Han Wui Then, Portland, OR (US); Milton Feng, Champaign, IL (US); Nick Holonyak, JR., Urbana, IL (US)

(21) Appl. No.: 13/136,710

(22) Filed: Aug. 8, 2011

Related U.S. Application Data
(60) Provisional application No. 61/401,501, filed on Aug. 13, 2010.

(51) Int. Cl. G02F 3/00

(52) U.S. Cl. 359/108

(57) ABSTRACT

A method for implementing an electro-optical logic function responsive to first and second logical inputs, includes the following steps: providing, as an output stage, a light-emitting transistor having an electrical input port and an optical output port; and providing, as an input stage, a circuit for receiving the first and second logical inputs and producing a control signal that is coupled with the electrical input port of the output stage.

### PRIORITY CLAIM

Priority is claimed from U.S. Provisional Patent Application Ser. No. 61/401,501, filed Aug. 13, 2010, and said U.S. Provisional Patent Application is incorporated herein by reference.

### FIELD OF THE INVENTION

This invention relates to the field of electro-optical logic circuits and techniques and, more particularly, to such circuits and techniques that employ light-emitting transistors and/or transistor lasers.

### BACKGROUND OF THE INVENTION

As computing grows increasingly more complex and performance goals escalate with the implementation of multi-core strategies and massively parallel computing, building blocks are needed that can perform at higher speeds, continue to scale with integrable components to achieve economies of scale, and satisfy the demand for interconnect speeds between each computing component and blocks of transistors. As the demand for lower power consumption (e.g., longer battery life) increases, copper interconnects are becoming more and more complex, and are expected to hit a stumbling block as increasing peripheral power (e.g., that consumed in pre-amplifier circuitry) will no longer meet the requirements for better performance at lower power. Photonics could provide the solution to both enabling massively parallel computing, and solving the problem of copper interconnects, thus ensuring that computing technology continues to grow and scale successfully. However, prior attempts at devising optical logic have encountered serious limitations. For example, two prior types of solution that have been proposed for all optical logic gates are based on: (1) Laser-PNPN thyristor switch, and (2) Laser-phototransistor. Both solutions have major disadvantages that could not be overcome. The major issue with a laser-photothyristor implementation is that the PNPN-thyristor has an extremely slow switching speed, typically in the MHz range. This fundamental limitation is owing to the saturated nature of PNPN switch operation. Once turned on, the PNPN device accumulates large quantities of charges in its base, and can take a long time just to turn off again. This sets a fundamental limit to the speed of the laser-photothyristor solution. Regarding a proposed all optical logic gate based on a laser-phototransistor, a key issue is that the solution requires a complex layer structure comprising layers of crystal growth to form a laser on top of a phototransistor, or vice versa. This results in very complex device fabrication. The manufacturing process has low yields and low repeatability, negating the possibility for very large scale integration.

The transistor has been the fundamental building block of electronic integrated circuits. In addition to its logic and switching capability, the transistor is also the ‘precursor’ to various circuit blocks because essential components such as amplifiers, resistors, varactors, and diodes can be fabricated from transistor structures. The transistor therefore enables the integration of multiple components on an integrated circuit or chip for logic, switching and various circuit applications.

A part of the background hereof lies in the development of heterojunction bipolar transistors which operate as light-emitting transistors and transistor lasers. Reference can be made for example, to U.S. Pat. Nos. 7,091,082, 7,286,583, 7,354,780, 7,535,034 and 7,693,195; U.S. Patent Application Publication Numbers US2005/0040432, US2005/0054172, US2008/0240173, US2009/0134939, and US2010/0034228; and to PCT International Patent Publication Numbers WO/2005/020287 and WO/2006/093883. Reference can also be made to the following publications: Light-Emitting Transistor: Light Emission From InGaP/GaAs Heterojunction Bipolar Transistors, M. Feng, N. Holonyak, Jr., and W. Hafez, Appl. Phys. Lett. 84, 151 (2004); Quantum-Well-Base Heterojunction Bipolar Light-Emitting Transistor, M. Feng, N. Holonyak, Jr., and R. Chan, Appl. Phys. Lett. 84, 1952 (2004); Type-II GaAsSb/InP Heterojunction Bipolar Light-Emitting Transistor, M. Feng, N. Holonyak, Jr., B. Chu-Kung, G. Walter, and R. Chan, Appl. Phys. Lett. 84, 4792 (2004); Laser Operation Of A Heterojunction Bipolar Light-Emitting Transistor, G. Walter, N. Holonyak, Jr., M. Feng, and R. Chan, Appl. Phys. Lett. 85, 4768 (2004); Microwave Operation And Modulation Of A Transistor Laser, R. Chan, M. Feng, N. Holonyak, Jr., and G. Walter, Appl. Phys. Lett. 86, 131114 (2005); Room Temperature Continuous Wave Operation Of A Heterojunction Bipolar Transistor Laser, M. Feng, N. Holonyak, Jr., G. Walter, and R. Chan, Appl. Phys. Lett. 87, 131103 (2005); Visible Spectrum Light-Emitting Transistors, F. Dixon, R. Chan, G. Walter, N. Holonyak, Jr., M. Feng, X. B. Zhang, J. H. Ryou, and R. D. Dupuis, Appl. Phys. Lett. 88, 012108 (2006); The Transistor Laser, N. Holonyak and M Feng, Spectrum, IEEE Volume 43, Issue 2, February 2006; Signal Mixing In A Multiple Input Transistor Laser Near Threshold, M. Feng, N. Holonyak, Jr., R. Chan, A. James, and G. Walter, Appl. Phys. Lett. 88, 063509 (2006); and Collector Current Map Of Gain And Stimulated Recombination On The Base Quantum Well Transitions Of A Transistor Laser, R. Chan, N. Holonyak, Jr., A. James, and G. Walter, Appl. Phys. Lett. 88, 14508 (2006); Collector Breakdown In The Heterojunction Bipolar Transistor Laser, G. Walter, A. James, N. Holonyak, Jr., M. Feng, and R. Chan, Appl. Phys. Lett. 88, 232105 (2006); High-Speed (/spl ges/1 GHz) Electrical And Optical Adding, Mixing, And Processing Of Square-Wave Signals With A Transistor Laser, M. Feng, N. Holonyak, Jr., R. Chan, A. James, and G. Walter, Photonics Technology Letters, IEEE Volume: 18 Issue: 11 (2006); Graded-Base InGaN/GaN Heterojunction Bipolar Light-Emitting Transistors, B. F. Chu-Kung et al., Appl. Phys. Lett. 89, 082108 (2006); Carrier Lifetime And Modulation Bandwidth Of A Quantum Well AlGaAs/InGaP/GaAs/InGaAs Transistor Laser, M. Feng, N. Holonyak, Jr., A. James, K. Cimino, G. Walter, and R. Chan, Appl. Phys. Lett. 89, 113504 (2006); Chirp In A Transistor Laser, Franz-Keldysh Reduction of The Linewidth Enhancement, G. Walter, A. James, N. Holonyak, Jr., and M. Feng, Appl. Phys. Lett. 90, 091109 (2007); Photon-Assisted Breakdown, Negative Resistance, And Switching In A Quantum-Well Transistor Laser, A. James, G. Walter, M. Feng, and N. Holonyak, Jr., Appl. Phys. Lett. 90, 152109 (2007); Franz-Keldysh Photon-Assisted Voltage-Operated Switching of a Transistor Laser, A. James, N. Holonyak, M. Feng, and G. Walter, Photonics Technology Letters, IEEE Volume: 19 Issue: 9 (2007); Experimental Determination Of The Effective Minority Carrier Lifetime In The Operation Of A Quantum-Well n-p-n Heterojunction Bipolar Light-Emitting Transistor Of Varying Base Quantum-Well Design And Doping; H. W. Then, M. Feng, N. Holonyak, Jr., and C. H. Wu, Appl. Phys. Lett. 91, 033505 (2007); Charge Control Analysis Of Transistor Laser Operation, M. Feng, N. Holonyak, Jr., H. W. Then, and G. Walter, Appl. Phys. Lett. 91, 053501 (2007); Optical Bandwidth Enhancement By Operation And Modulation Of The First Excited State Of A Transistor Laser, H. W. Then, M. Feng, and N. Holonyak, Jr., Appl. Phys. Lett. 91, 183505 (2007); Modulation Of High Current Gain (β>49) Light-Emitting InGaN/GaN Heterojunction Bipolar Transistors, B. F. Chu-Kung, C. H. Wu, G. Walter, M. Feng, N. Holonyak, Jr., T. Chung, J.-H. Ryou, and R. D. Dupuis, Appl. Phys. Lett. 91, 232114 (2007); Collector Characteristics And The Differential Optical Gain Of A Quantum-Well Transistor Laser, H. W. Then, G. Walter, M. Feng, and N. Holonyak, Jr., Appl. Phys. Lett. 91, 243508 (2007); Transistor Laser With Emission Wavelength at 1544 nm, F. Dixon, M. Feng, N. Holonyak, Jr., Yong Huang, X. B. Zhang, J. H. Ryou, and R. D. Dupuis, Appl. Phys. Lett. 93, 021111 (2008); Optical Bandwidth Enhancement Of Heterojunction Bipolar Transistor Laser Operation With An Auxiliary Base Signal, H. W. Then, G. Walter, M. Feng, and N. Holonyak, Jr. Appl. Phys. Lett. 93, 163504 (2008). Bandwidth extension by trade-off of electrical and optical gain in a transistor laser, Three-terminal control, H. W. Then, M. Feng, and N. Holonyak, Jr. Appl. Phys. Lett.94, 013509 (2009). Tunnel Junction Transistor Laser, M. Feng, N. Holonyak, Jr., H. W. Then, C. H. Wu, and G. Walter Appl. Phys. Lett 94, 041118 (2009); Electrical-Optical Signal Mixing And Multiplication (2→22 GHz) With A Tunnel Junction Transistor Laser, H. W. Then, C. H. Wu, G. Walter, M. Feng, and N. Holonyak, Jr. Appl. Phys. Lett. 94, 101114 (2009); Scaling Of Light Emitting Transistor For Multigigahertz Optical Bandwidth, C. H. Wu, G. Walter, H. W. Then, M. Feng, and N. Holonyak, Jr. Appl. Phys. Lett. 94, 171101 (2009); Device Performance Of Light Emitting Transistors With C-Doped And Zn-Doped Base Layers; Huang, Y.; Ryou, J.-H.; Dupuis, R. D.; Dixon, F.; Holonyak, N.; Feng, M.; Indium Phosphide & Related Materials, 2009; Tilted-Charge High Speed (7 GHz) Light Emitting Diode, G. Walter, C. H. Wu, H. W. Then, M. Feng, and N. Holonyak, Jr. Appl. Phys. Lett. 94, 231125 (2009); 4.3 GHz Optical Bandwidth Light Emitting Transistor, G. Walter, C. H. Wu, H. W. Then, M. Feng, and N. Holonyak, Jr., Appl. Phys. Lett. 94, 241101 (2009) Received: 29 Jan. 2009; accepted: 17 Apr. 2009; published online: 15 Jun. 2009. Resonance-Free Frequency Response Of A Semiconductor Laser, M. Feng, H. W. Then, N. Holonyak, Jr., G. Walter, and A. James, Appl. Phys. Lett. 95, 033509 (2009).

It is among the objectives here to achieve improvements in electro-optical logic functions and circuits, by advantageously utilizing light-emitting transistors, transistor lasers, and related structures for implementing NOR functions and other logic functions needed for high speed opto-electronic systems and methods.

### SUMMARY OF THE INVENTION

The advent of the light-emitting transistor and transistor laser allows the integration of the transistor and laser as a single component or device, adding a natural photonic component to integrated circuits. The light-emitting transistor and transistor laser, due to its direct-gap (III-V semiconductor) structure, possesses a major advantage over its purely electrical cousin: it has the capability of processing (receive, transform and transmit) both electrical and optical signals. For example, besides performing its usual electrical signal processing functions, a light-emitting transistor can convey its output signal via either an electrical output or, where desired, it can propagate the output signals in the form of an optical signal, thereby allowing near lossless, high-speed optical signal transmission (e.g. in optical waveguides) over distances unreachable by copper interconnects.

By adding a ‘third’ optical dimension, the light-emitting transistor can provide a new scalable and integrable building block for massive arrays that can be addressed simultaneously instead of by the usual multiplexed approach. This enables information to be processed and transmitted simultaneously. Arrays of optical switches and logic gates made from light-emitting transistors can thus, for example, provide the building blocks for constructing a very large scale parallel integrated optical network and logic functions for massively parallel computing.

A form of the invention hereof comprises a universal electro-optical NOR gate based on the light-emitting transistor (LET) or transistor laser (TL), from which all other logic functions may be constructed. The optical NOR gate can, for example, form a building block for a larger optical based network to support massive parallel computing. Moreover, due to its inherent transistor structure, the same device or component can be fabricated into electrical logic building blocks for computing and for other traditional (electronic) information processing functions as well. Moreover, all the required components for integrated circuits can be fabricated on a single epitaxial structure for the light-emitting transistor, thus facilitating integration on a very large scale and driving economies of scale.

In accordance with an embodiment of the invention, a method is set forth for implementing an electro-optical logic function, such as a NOR function, responsive to first and second logical inputs, comprising the following steps: providing, as an output stage, a light-emitting transistor having an electrical input port and an optical output port; and providing, as an input stage, a circuit for receiving said first and second logical inputs and producing a control signal that is coupled with the electrical input port of said output stage. In one embodiment, at least one of said logical inputs is an optical input, and the step of providing, as an input stage, a circuit for receiving said first and second logical inputs, comprises providing an electro-optical circuit for receiving said first and second logical inputs. In this embodiment, the step of providing, as an input stage, an electro-optical circuit, comprises providing an electro-optical circuit that includes a phototransistor, which can preferably be a light-emitting transistor configured as a phototransistor. The output stage light-emitting transistor and the light emitting transistor configured as a phototransistor can advantageously have a substantially common semiconductor layer structure.

In an embodiment of the method of the invention, the step of providing said electro-optical circuit comprises providing a circuit that further includes a light-emitting transistor configured as a resistor, and further comprises arranging said light-emitting transistor configured as a resistor and said light-emitting transistor configured as a phototransistor in a biased series arrangement, such that the signal level at a terminal of said resistor depends on whether a logical input signal is being received by said phototransistor. In this embodiment, the step of producing a control signal comprises producing a voltage applied as the collector voltage of the light-emitting transistor of the output stage. The recited light-emitting transistors can comprise transistor lasers and/or tunnel junction transistor lasers. Also, other logical functions can be implemented.

As will also be described, a bistable latch function is implemented by combining first and second NOR gate functions in accordance with an embodiment of the invention. In an embodiment thereof, each of said NOR gate functions is adapted to receive, as one of its inputs, a signal derived from the output of the other NOR gate function.

In accordance with a further embodiment of the invention, a method is set forth for implementing a universal electro-optical logic function responsive to plural logical inputs, comprising the following steps: providing, on a common substrate, first, second, and third transistor structures having substantially common semiconductor layering; configuring said third transistor structure as a light-emitting transistor output stage having an electrical input port, an electrical output port, and an optical output port; configuring said first transistor structure to operate as a resistor; configuring said second transistor structure to operate as a phototransistor; and providing, as an input stage, an electro-optical circuit that includes said configured first and second transistor structures, for receiving a plurality of logical inputs and producing a control signal that is coupled with the electrical input port of said output stage.

Further features and advantages of the invention will become more readily apparent from the following detailed description when taken in conjunction with the accompanying drawings.

### BRIEF DESCRIPTION OF THE DRAWINGS

FIG. 1 is a simplified representation of an electro-optical universal NOR gate in accordance with an embodiment of the invention.

FIG. 2A is a logic table for a three input (two optical and one electrical) electro-optical NOR gate.

FIG. 2B is a logic table for a two input all-optical NOR gate.

FIG. 2C is a logic table for a two input (one optical and one electrical) electro-optical NOR gate.

FIG. 3 shows, for a transistor laser, collector current as a function of V_{CE} for different values of base current.

FIG. 4 shows, for a transistor laser, fiber-coupled optical power output as a function of V_{CE} for different values of base current.

FIG. 5 shows a circuit in accordance with an embodiment of the invention for implementing a universal electro-optical NOR gate device and method.

FIG. 6 shows the variation of the FIG. 5 circuit for implementing the logic function represented by the table of FIG. 2B.

FIG. 7 shows the variation of the FIG. 5 circuit for implementing the logic function represented by the table of FIG. 2C.

FIGS. 8A, 8B, and 8C illustrate an example of operation when the NOR gate circuit is receiving all logical “0” inputs and a logical “1” optical output is produced. FIG. 8A shows the circuit and exemplary parameters, FIG. 8B shows, for a transistor laser, collector current as a function of V_{CE} for different values of base current, and FIG. 8C shows, for a transistor laser, fiber-coupled optical power as a function of VCE, for different values of base current.

FIGS. 9A through 9F illustrate an example of operation when the output logic is “0”. FIG. 9A shows an example of the electrical parameters when TL0 receives either or both of two logical “1” optical inputs, which will result in no optical output from TL2. FIG. 9B shows a similar turning-on of TL0 can be via electrical input S=“1” (and/or an optical input). FIG. 9C shows the change in collector current of TL0 (from 0 to 5 mA) as an optical input is increased (or, alternatively, as an electrical input to TL0 in FIG. 9B), and FIG. 9D shows the concomitant increase in voltage across TL1 (i.e., V_{CE} of TL1). FIG. 9E shows how the increased V_{CE} of TL2 results in the reduction of base and collector currents of TL2, and FIG. 9F shows the resultant reduction and turn-off of the TL2 optical output.

FIG. 10 shows a table that summarizes the combinations of electrical and optical parameters for a three input NOR gate of an example of an embodiment being described.

FIG. 11A shows an embodiment of an all-optical bistable latch that employs two universal NOR gates. FIG. 11B shows a logic table for the bistable latch of FIG. 11A.

FIG. 12A shows an electrical-in optical-out version of the bistable latch. FIG. 12B shows a logic table for the bistable latch of FIG. 12A.

FIG. 13A shows an optical-in electrical-out version of the bistable latch. FIG. 13B shows a logic table for the bistable latch of FIG. 13A.

### DETAILED DESCRIPTION

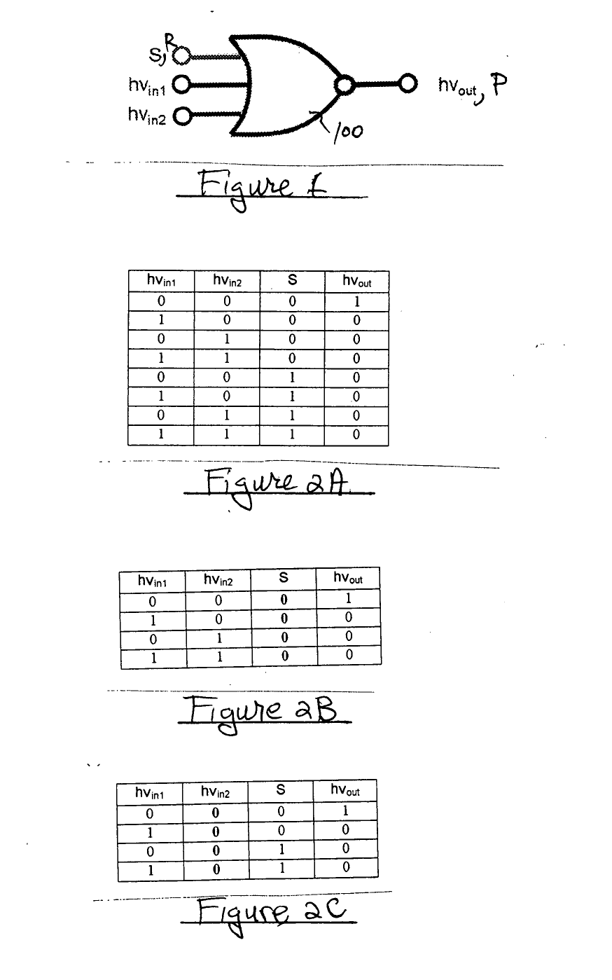

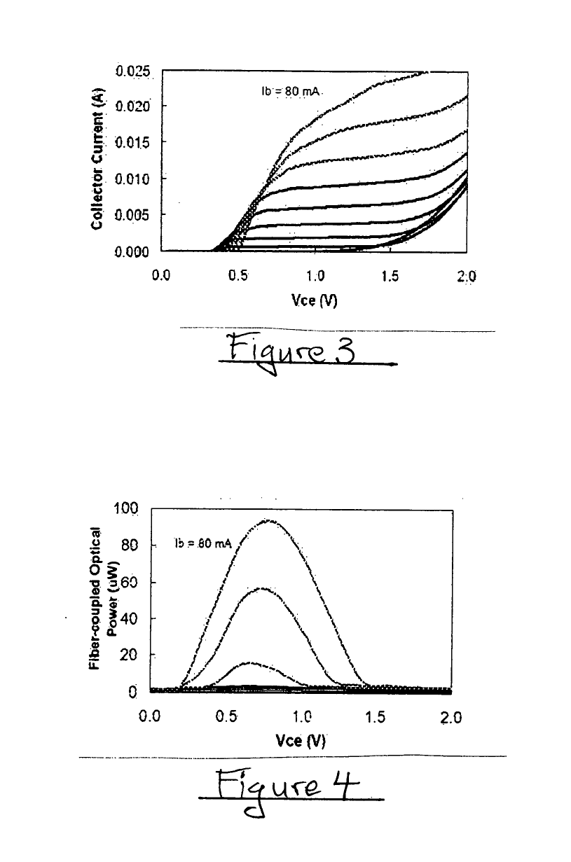

FIG. 1 illustrates the operation of an embodiment of a universal electro-optical NOR gate 100 which receives two or more signals as inputs. As seen in FIG. 1, the signals can be in the form of optical signals, hvᵢₙ₁ and hvᵢₙ₂, or electrical signals, S, R. It then performs a logic operation, NOR, on the input signals (see logic table of FIG. 2A), and produces its result in the form of an output signal that could be either optical, hvₒᵤₜ or electrical, P. For example, if the NOR gate receives no input signal (i.e., all inputs “0”), it will produce an output signal (“1”). If there is a signal detected at the input (i.e., any input is a “1”), the NOR gate will turn off its output signal, hence outputting a logic “0”.

FIG. 2A shows the logic table for the case of two optical inputs, one electrical input, and an optical output. The table has eight rows representing the eight possible combinations of three binary inputs (2³). FIG. 2B shows the logic table for the case of two optical inputs (the electrical input being set to “0”) and FIG. 2C shows the logic table for the case of one optical input and one electrical input (the second optical input being set to “0”).

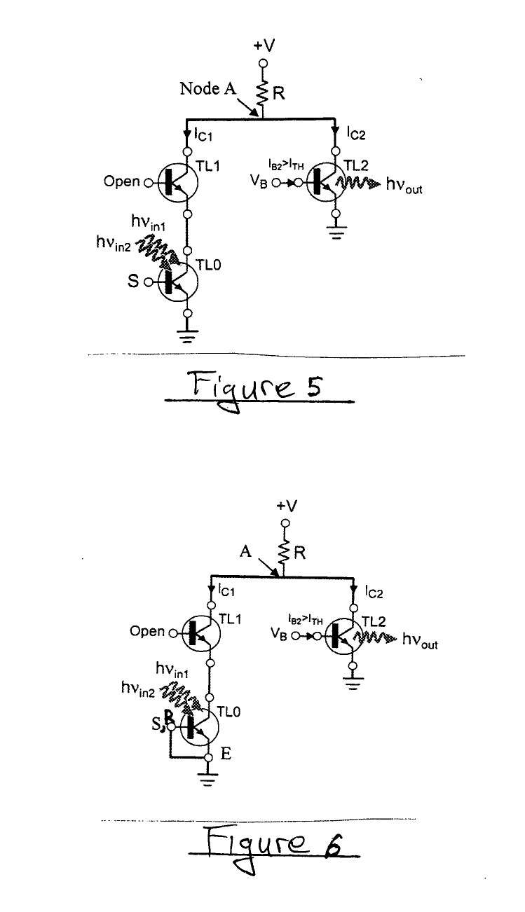

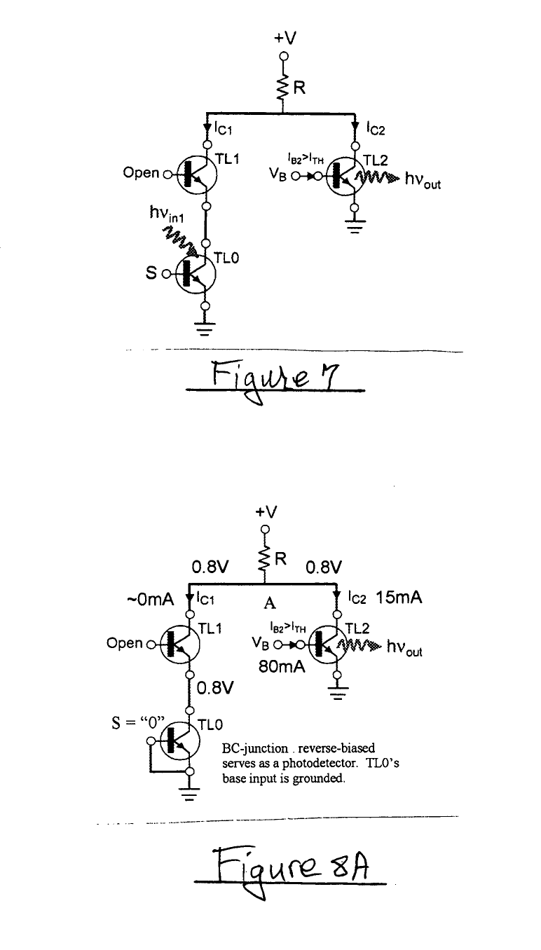

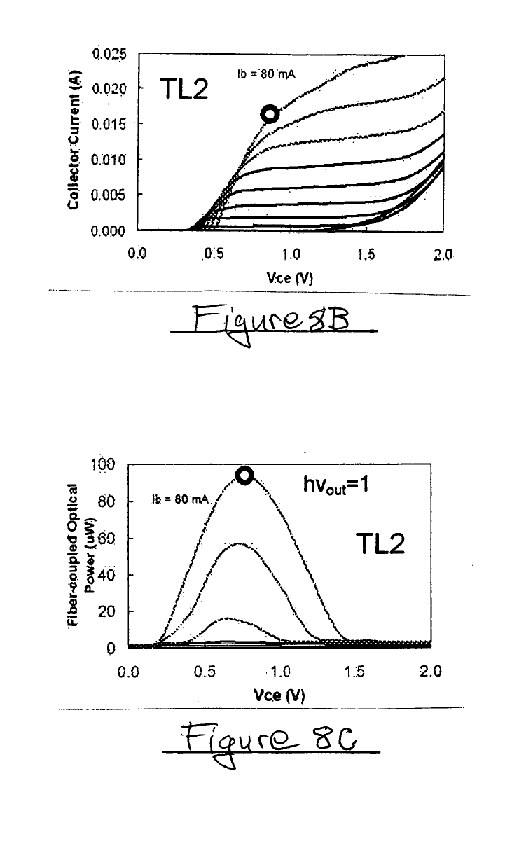

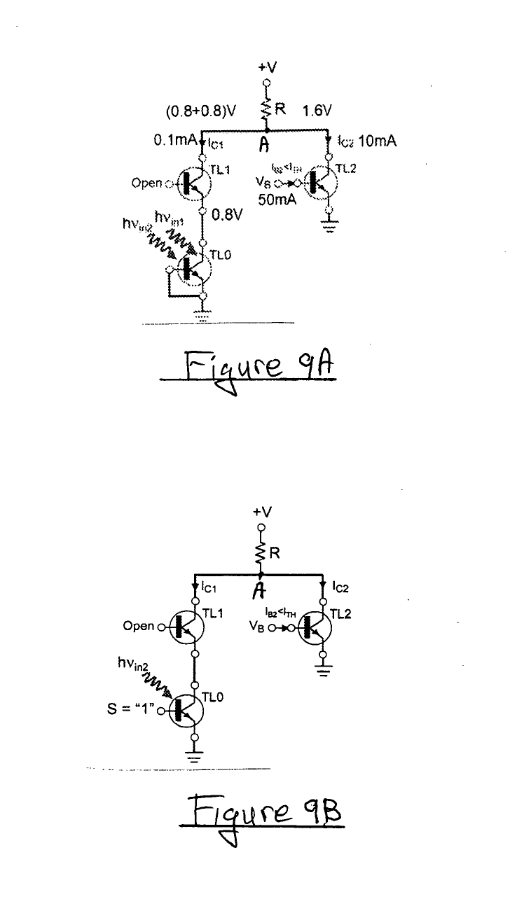

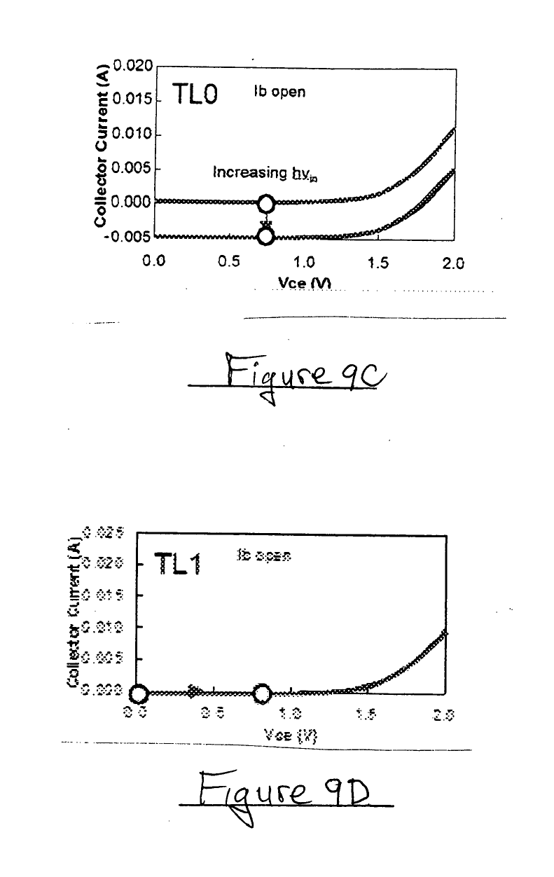

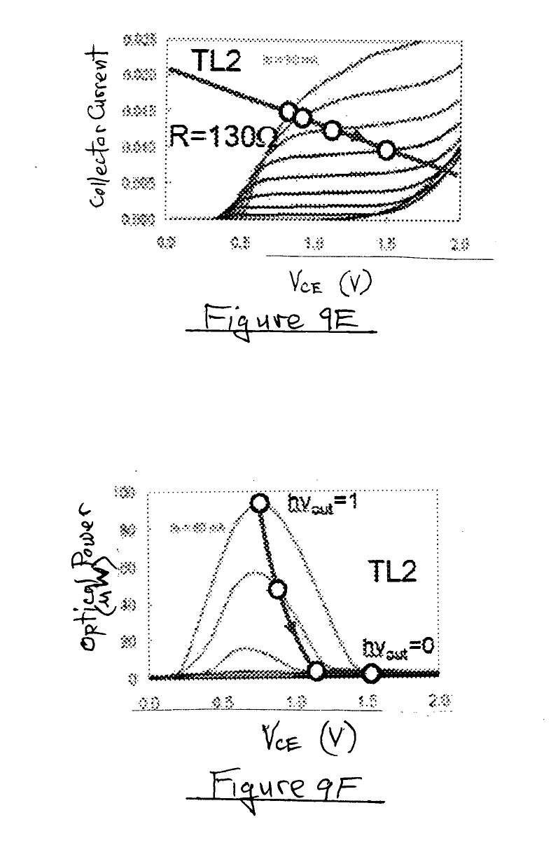

In an embodiment hereof, in constructing a NOR gate from a light-emitting transistor, both its electrical and optical functionalities are utilized. A light-emitting transistor laser with a collector tunnel junction design (see e.g. U.S. Patent Application Publication No. US2010/0085995) is employed in this example for illustration. Its electrical and optical properties are shown in FIGS. 3 and 4. FIG. 3 shows collector current as a function of V_{CE} for different values of base current. FIG. 4 shows fiber-coupled optical power output as a function of V_{CE} for different values of base current.

FIG. 5 shows a circuit in accordance with an embodiment of the invention for implementing the universal electro-optical NOR gate device and method. In this embodiment, three units having the layer structure of a light-emitting transistor or transistor laser are employed, each with its own functionality. In this embodiment, an input stage includes transistor laser structures TL0 and TL1 in series, and an output stage includes transistor laser TL2. The collector terminals of TL1 and TL2 are biased with voltage +V via resistor R. TL0 functions as a photodetector, in the form of a phototransistor, to receive the external inputs, hvᵢₙ₁ and hvᵢₙ₂, of the NOR gate. The base terminal of TL0 is grounded to its emitter terminal. TL0's base terminal can alternatively serve as an electrical input, S. In the illustrated embodiment, TL1 functions as a large resistor, and serves as a means of potential control. However, it may not be necessary in the implementation if TL0 could swing its collector-emitter voltage sufficiently to turn off TL2. An inverter topology is used, connecting the input stage transistor laser TL0 with the output stage transistor laser, TL2. TL2 acts as a switch controlled by the potential V_{B} (its base voltage), and the potential at the node A (its collector voltage). The potential at A is controlled by TL0 and TL1. Node A's potential can serve as an electrical output as well but its output logic is an OR of the logical inputs. (This could be rendered a NOR, using a NOT gate.) When V_{B} is applied such that the supply current, I_{B2} exceeds the laser threshold, I_{TH}, TL2 remains “on”, or outputting an optical signal, hvₒᵤₜ, as long as all inputs to the NOR gate are “0”. (This logic state is described operationally hereinbelow in conjunction with FIGS. 8A, 8B, and 8C.) Accordingly, the logic table of FIG. 2A is seen to apply.

FIG. 6 shows the variation of the FIG. 5 circuit for implementing the logic function represented by the table of FIG. 2B. In this case, the base terminal of TL0 is grounded to the emitter terminal thereof. Now, consistent with the FIG. 2B table, a logical “1” output of TL2 will only occur if both optical inputs are logical “0”.

FIG. 7 shows the variation of the FIG. 5 circuit for implementing the logic function represented by the table of FIG. 2C. In this case TL0 has electrical input S, R and one optical input, and, consistent with the FIG. 2C table, a logical “1” output of TL2 will occur only if both of these inputs are logical

FIGS. 8A, 8B, and 8C illustrate an example of operation when the NOR gate circuit is receiving all logical “0” inputs and a logical “1” optical output is produced. In this case, the potential at node A is (for illustrative purposes) 0.8 V and V_{B} supplies a base current to TL2, enabling TL2 to emit an output laser signal (i.e., a logical “1” output). No current flows in TL0 and TL1 because the effective impedance (with TL0 turned off) is very high. In this example, the operating Q-point of TL2 is shown by the open circle in FIG. 8B, and the light emission of TL2 is shown by the open circle in FIG. 8C.

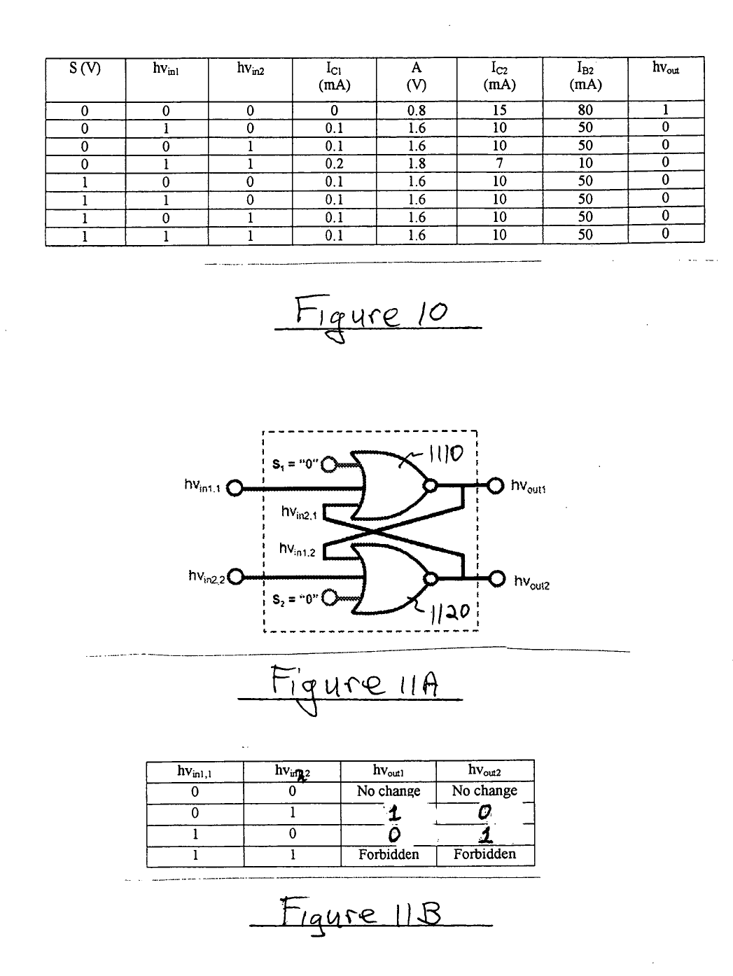

If an optical signal of a particular strength (power) is incident on TL0, TL0 will switch to a low impedance state and a current will be conducted through TL1. Consequently, the potential at A will be raised sufficiently to switch off TL2, thus rendering its output a logic “0”. The output logic “0” case is shown FIGS. 9A through 9F. FIG. 9A shows an example of the electrical parameters when TL0 receives either or both of two “logical 1” optical inputs, which will result in no optical output from TL2 (i.e., a logical “0” output of the NOR gate circuit). In this case, TL0 will turn on, resulting in a voltage at node A, for this example, of (0.8+0.8) V=1.6V, and the turning off of the optical output of TL2. [A similar turning-on of TL0 can be via electrical input S=“1” (or an optical input thereto), as shown in FIG. 9B.] In both cases the current input to TL2 (I_{B2}) will be less than the threshold for light emission (I_{TH}) at the indicated collector voltage. FIG. 9C shows the change in collector current of TL0 (from 0 to 5 mA) as an optical input is increased (or, alternatively, as an electrical input to TL0 in FIG. 9B), and FIG. 9D shows the concomitant increase in voltage across TL1 (i.e., V_{CE} of TL1). FIG. 9E shows how the increased V_{CE} of TL2 results in the reduction of base and collector currents of TL2, and FIG. 9F shows the resultant reduction and turn-off of the TL2 optical output.

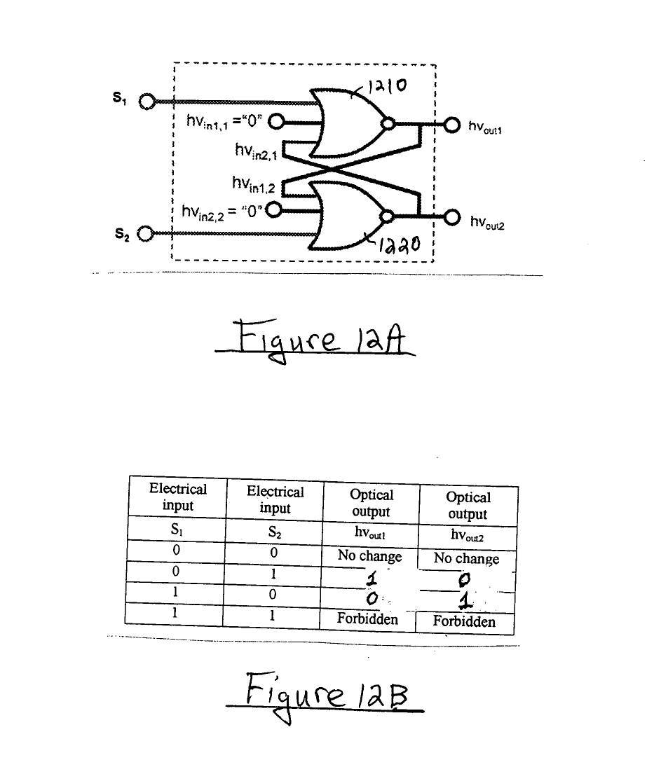

The table of FIG. 10 summarizes the combinations of electrical and optical parameters for a three input NOR gate of the example of the present embodiment. The eight rows show the eight combinations of the three logical inputs (two optical and one electrical), similar to FIG. 2A first shown above. Also shown, in the fourth column (from the left) of FIG. 10, is the collector current of TL1, in the fifth column is the voltage at node A, in the sixth column is the collector current of TL2, in the seventh column is the base current of TL2, and in the eighth column is the logic of the optical output of TL2. As seen, an output logic “0” is obtained when the potential at node A is increased to 1.6 V as a result of current flow in TL0 induced by an input optical signal hvᵢₙ₁, or by a voltage applied at S. As a result of the increase in the potential at node A, the operating Q-point of TL2 shifts towards the right of the I-V and optical emission family of curves, thereby switching off TL2. V_{B} (the base voltage of TL2) drops the base current to below the laser threshold current. Note that while hvₒᵤₜ is a NOR output of the inputs hvᵢₙ₁ hvᵢₙ₂ and S, A is an OR output of the same inputs when 0.8V is regarded as logic “0” and 1.6V or more is regarded as logic “1”.

FIG. 11A shows an embodiment of an all-optical bistable latch that employs two of the universal NOR gates, 1110 and 1120, that were previously described, and each of which operates in an all-optical mode for this embodiment. Latches are important, for example, as storage elements. In the FIG. 11A embodiment, each of the NOR gates has its electrical input (S) set at “0” (e.g., was shown in FIG. 6 above). The NOR gate 1110 receives an optical input signal designated hν_{in1,1,} and the NOR gate 1120 receives an optical input signal designated hν_{1n2,2.} The optical output of NOR gate 1110 is also fed back to a second optical input of NOR gate 1120, and, the optical output of NOR gate 1120 is fed back to a second optical input of NOR gate 1110.

Operation of the bistable latch of the FIG. 11A embodiment is summarized in the logic table of FIG. 11B. As seen in the table, when hν_{in1,1} is “0” and hν_{in2,2} is “1” (second row of table) the output state (e.g. a set state) has hνₒᵤₜ₁ at “1” and hνₒᵤₜ₂ at “0”. [This is readily understood by recognizing that the presence of a “1” input to NOR gate 1120 will render its output “0” (i.e., hνₒᵤₜ₂=“0”). Thus, since hνₒᵤₜ₂ is fed back to NOR gate 1110 as input hν_{in2,1} all inputs to NOR gate 1110 will be “0”, so its output will be “1” (i.e., hνₒᵤₜ₁=“1”).] Now, if hν_{in2,2}, changes state to “0” (first row of table), there will be no change of the output states, since the input hν_{in2,1} to t NOR gate 1120 will still be “1”, which will keep the output of NOR gate 1120 at “0”. The third row of the FIG. 11B table (e.g. a “reset” state) can be described similarly, with opposite sense. The fourth row describes the invalid or metastable state (“forbidden”) of the bistable latch.

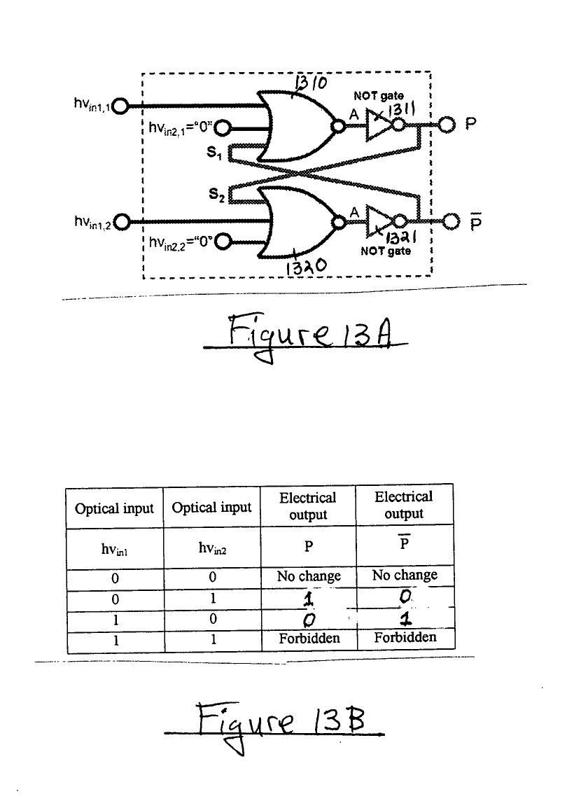

FIG. 12A shows an electrical-in optical-out version of the bistable latch. In this version, the NOR gates are labeled 1210 and 1220, and the fed-back arrangement of optical outputs are similar to the FIG. 11A arrangement. In this case, optical inputs hν_{in1,1} and hν_{in2,2} are set to “0” and electrical inputs S₁ and S₂ are used. The corresponding logic table is shown in FIG. 12B, and is seen to be similar to the table of FIG. 11B, except that the inputs are electrical rather than optical.

FIG. 13A shows an optical-in electrical-out version of the bistable latch. In this version, the NOR gates are labeled 1210 and 1220, and the electrical outputs of the gates, taken at node A, are representative of “OR” logic, as was described above. Accordingly, in this embodiment, electrical NOT gates 1311 and 1321 are used to convert the electrical outputs to NOR logic. These electrical outputs are fed back to the electrical inputs (S₁ and S₂, input to the base of TL0, e.g. in FIG. 7), of the respective other gates. In this case, each gate has one variable optical input (hν_{in1,1} and hν_{in1,2,} respectively) and one optical input fixed at “0” (hν_{in2,1} and hν_{in2,2}, respectively). The corresponding logic table is shown in FIG. 13B, and is again seen to be similar to the table of FIG. 11B, but with outputs being electrical outputs designated P and P̅.

1. A method for implementing an electro-optical logic function responsive to first and second logical inputs, comprising the steps of:
providing, as an output stage, a light-emitting transistor having an electrical input port and an optical output port; and
providing, as an input stage, a circuit for receiving said first and second logical inputs and producing a control signal that is coupled with the electrical input port of said output stage.

2. The method as defined by claim 1, wherein at least one of said logical inputs is an optical input, and wherein said step of providing, as an input stage, a circuit for receiving said first and second logical inputs, comprises providing an electro-optical circuit for receiving said first and second logical inputs.

3. The method as defined by claim 2, wherein said step of providing, as an input stage, an electro-optical circuit, comprises providing an electro-optical circuit that includes a phototransistor.

4. The method as defined by claim 3, wherein said step of providing said electro-optical circuit that includes a phototransistor comprises providing said phototransistor as a light-emitting transistor configured as a phototransistor.

5. The method as described by claim 4, wherein said first and second logical inputs are optical inputs, and further comprising applying said first and second optical inputs to said light-emitting transistor configured as a phototransistor.

6. The method as defined by claim 4, wherein said first logical input is an optical input and said second logical input is an electrical input, and further comprising applying said optical input and said electrical input to said light-emitting transistor configured as a phototransistor.

7. The method as defined by claim 4, further comprising providing said output stage light-emitting transistor and said light emitting transistor configured as a phototransistor with a substantially common semiconductor layer structure.

8. The method as defined by claim 3, wherein said step of providing said electro-optical circuit comprises providing a circuit that further includes a light-emitting transistor configured as a resistor, and further comprising arranging said light-emitting transistor configured as a resistor and said light-emitting transistor configured as a phototransistor in a biased series arrangement, such that the signal level at a terminal of said resistor depends on whether a logicall input signal is being received by said phototransistor.

9. The method as defined by claim 2, wherein said step of producing a control signal comprises producing a voltage applied as the collector voltage of the light-emitting transistor of said output stage.

10. The method as defined by claim 2, wherein said step of providing said output stage light-emitting transistor comprises providing said light-emitting transistor as a transistor laser.

11. The method as defined by claim 10, wherein said step of providing said transistor laser comprises providing a tunnel junction transistor laser.

12. The method as defined by claim 2, wherein said electro-optical logic function comprises a NOR function.

13. A method for implementing a bistable latch function comprising combining first and second NOR gate functions as defined by claim 12.

14. The bistable latch function as defined by claim 13, wherein each of said NOR gate functions is adapted to receive, as one of its inputs, a signal derived from the output of the other NOR gate function.

15. The bistable latch function as defined by claim 14, wherein an output of said latch function comprises an optical signal.

16. The bistable latch function as defined by claim 14, wherein at least one input of said latch function comprises an optical signal.

17. The method as defined by claim 2, wherein said step of providing a light-emitting transistor output stage comprises providing a light-emitting transistor having and electrical input port, an optical output port, and an electrical output port.

18. A method for implementing a universal electro-optical logic function responsive to plural logical inputs, comprising the steps of:
providing, on a common substrate, first, second, and third transistor structures having substantially common semiconductor layering;
configuring said third transistor structure as a light-emitting transistor output stage having an electrical input port, and electrical output port, and an optical output port;
configuring said first transistor structure to operate as a resistor;
configuring said second transistor structure to operate as a phototransistor; and
providing, as a input stage, an electro-optical circuit that includes said configured first and second transistor structures, for receiving a plurality of logical inputs and producing a control signal that is coupled with the electrical input port of said output stage.

19. The method as defined by claim 18, wherein at least one of said logical inputs is an optical input, and further comprising applying said optical input to said second transistor structure configured to operate as a phototransistor.

20. The method as defined by claim 19, wherein at least one of said logical inputs is an electrical input, and further comprising applying said electrical input to said second transistor structure.

21. The method as defined by claim 18, wherein said step of producing a control signal comprises producing a voltage applied as the collector voltage of the light-emitting transistor of said output stage.

22. The method as defined by claim 18, wherein said step of providing said output stage light-emitting transistor comprises providing said light-emitting transistor as a transistor laser.

23. The method as defined by claim 22, wherein said step of providing said transistor laser comprises providing a tunnel junction transistor laser.

24. An electro-optical logic gate responsive to first and second logical inputs, comprising:
an output stage including a light-emitting transistor having an electrical input port and an optical output port; and
an input stage including a circuit for receiving said first and second logical inputs and producing a control signal that is coupled with the electrical input port of said output stage.

25. The logic gate as defined by claim 24, wherein at least one of said logical inputs is an optical input, and wherein said input stage circuit for receiving said first and second logical inputs comprises an electro-optical circuit for receiving said first and second logical inputs.

26. The logic gate as defined by claim 25, wherein input stage electro-optical circuit comprises a phototransistor.

27. The logic gate as defined by claim 26, wherein said phototransistor comprises a light-emitting transistor configured as a phototransistor.

28. The logic gate as defined by claim 27, wherein said output stage light-emitting transistor and said light emitting transistor configured as a phototransistor have a substantially common semiconductor layer structure.

29. The logic gate as defined by claim 25, wherein said output stage light-emitting transistor comprises a transistor laser.

30. The logic gate as defined by claim 29, wherein said transistor laser comprises a tunnel junction transistor laser.

31. The logic gate as defined by claim 25, wherein said logic gate comprises a NOR gate.

32. A bistable latch comprising a combination of first and second NOR gates as defined by claim 31.
